(19) United States
(12) Patent Application Publication
(10) Pub. No.: US 2020/0413241 A1
(43) Pub. Date: Dec. 31, 2020

(54) METHOD FOR TERMINAL SETTING UPDATE IN WIRELESS COMMUNICATION SYSTEM AND APPARATUS THEREFOR

(71) Applicant: LG ELECTRONICS INC., Seoul (KR)

(72) Inventors: Sangmin PARK, Seoul (KR); Jaehyun KIM, Seoul (KR)

(73) Assignee: LG ELECTRONICS INC., Seoul (KR)

(21) Appl. No.: 16/969,951

(22) PCT Filed: Feb. 19, 2019
(86) PCT No.: PCT/KR2019/001957

§ 371 Date: Aug. 13, 2020

Related U.S. Application Data
(60) Provisional application No. 62/631,950, filed on Feb. 19, 2018.

(51) Int. Cl. H04W 8/02; H04W 76/18; H04W 76/34

(52) U.S. Cl. CPC H04W 8/02; H04W 76/34; H04W 76/18

(57) ABSTRACT

An aspect of the present invention relates to a method for a user equipment configuration update (UCU) of a terminal in a wireless communication system, the method comprising the steps of; receiving a setting update instruction message for updating a set of the terminal from an access and mobility management function (AMF), wherein the setting update instruction message includes rejected single-network slice selection assistance information(S-NSSAI) for the terminal and a rejection reason; and storing, on the basis of the rejection reason, the rejected S-NSSAI in rejected NSSAI.

### TECHNICAL FIELD

The present disclosure relates to a wireless communication system, and more particularly to a user equipment configuration update method and a device therefor.

### BACKGROUND ART

Mobile communication systems have been developed to provide voice services while ensuring activity of users. However, coverage of mobile communication systems has been extended to include data services, as well as voice services, resulting in an explosive increase in traffic and shortage of resources. To meet the demands of users expecting relatively high speed services, an advanced mobile communication system is required.

Requirements of a next-generation mobile communication system include accommodation of increased amounts of data traffic, a significant increase in a transfer rate per user, accommodation of considerably increased number of connection devices, very low end-to-end latency, and high energy efficiency. To this end, there have been researched various technologies such as dual connectivity, massive multiple input multiple output (MIMO), in-band full duplex, non-orthogonal multiple access (NOMA), super wideband, device networking, and the like.

### DISCLOSURE

### Technical Problem

According to a related art, because NSSAI information explicitly rejected by a network node is not indicated to a user equipment (UE), there is a problem that the UE unnecessarily requests a service for rejected NSSAI. The present disclosure describes embodiments for solving the problem.

Embodiments for a method and a device for solving the above-described technical problem are described. The technical problems to be solved by the present disclosure are not limited by the above-mentioned technical problems, and other technical problems which are not mentioned above can be clearly understood from the following description by those skilled in the art to which the present disclosure pertains.

### Technical Solution

In one aspect, there is provided a user equipment configuration update (UCU) method of a user equipment (UE) in a wireless communication system, the UCU method comprising receiving a configuration update command message for updating a configuration of the UE from an access and mobility management function (AMF), the configuration update command message including rejected single-network slice selection assistance information (S-NSSAI) for the UE and a rejection cause; and storing the rejected S-NSSAI in rejected NSSAI based on the rejection cause.

The rejected S-NSSAI may be comprised of a slice/service type (SST) and a slice differentiator (SD).

The SST may refer to an expected network slice behavior in terms of features and services, and the SD may refer to optional information that complements the SST to differentiate among multiple network slices of the same slice/service type.

The configuration update command message may further include allowed NSSAI updated for the UE.

The UCU method may further comprise, based on the configuration update command message including the updated allowed NSSAI, storing the updated allowed NSSAI based on considering the updated allowed NSSAI as valid.

Based on the configuration update command message including registration request information, a negotiation between the UE and a network may be initiated.

The rejection cause may indicate that the rejected S-NSSAI is not available in a current public land mobile network (PLMN) of the UE, and/or the rejected S-NSSAI is not available in a current registration area of the UE.

Storing the rejected S-NSSAI in the rejected NSSAI based on the rejection cause may comprise storing the rejected S-NSSAI in the rejected NSSAI based on dividing the rejected S-NSSAI per the rejection cause.

Based on S-NSSAI associated with a currently active protocol data unit (PDU) session being not included in the updated allowed NSSAI, and/or being included in the rejected NSSAI, the AMF may be a network node informing a release of the PDU session to a SMF associated with the PDU session.

In another aspect, there is provided a user equipment (UE) performing a user equipment configuration update (UCU) method in a wireless communication system, the UE comprising a communication module configured to transmit and receive a signal; a memory configured to store data; and a processor configured to control the communication module and the memory, wherein the processor is configured to receive a configuration update command message for updating a configuration of the UE from an access and mobility management function (AMF), the configuration update command message including rejected single-network slice selection assistance information (S-NSSAI) for the UE and a rejection cause, and store the rejected S-NSSAI in rejected NSSAI based on the rejection cause.

The configuration update command message may further include allowed NSSAI updated for the UE.

Based on the configuration update command message including the updated allowed NSSAI, the processor may be configured to store the updated allowed NSSAI based on considering the updated allowed NSSAI as valid.

Based on the configuration update command message including registration request information, a negotiation between the UE and a network may be initiated.

The rejection cause may indicate that the rejected S-NSSAI is not available in a current public land mobile network (PLMN) of the UE, and/or the rejected S-NSSAI is not available in a current registration area of the UE.

Based on the rejected S-NSSAI being stored in the rejected NSSAI based on the rejection cause, the processor may be configured to store the rejected S-NSSAI in the rejected NSSAI based on dividing the rejected S-NSSAI per the rejection cause.

Based on S-NSSAI associated with a currently active protocol data unit (PDU) session being not included in the updated allowed NSSAI, and/or being included in the rejected NSSAI, the AMF may be a network node informing a release of the PDU session to a SMF associated with the PDU session.

In another aspect, there is provided an access and mobility management function (AMF) performing a user equipment configuration update (UCU) method in a wireless communication system, the AMF comprising a communication module configured to transmit and receive a signal; a memory configured to store data; and a processor configured to control the communication module and the memory, wherein the processor is configured to send a configuration update command message for updating a configuration of a user equipment (UE) to the UE, wherein the configuration update command message includes rejected single-network slice selection assistance information (S-NSSAI) for the UE and a rejection cause.

### Advantageous Effects

According to embodiments of the present disclosure, because rejected NSSAI is explicitly indicated to a UE by a network node, they can solve problems of an increase in signalling overhead, a waste of radio/wired resources, etc. that may occur as the UE requests a service for the rejected NSSAI

Effects which can be obtained in the present disclosure are not limited to the aforementioned effects, and other unmentioned effects will be clearly understood by those skilled in the art from the following description.

### DESCRIPTION OF DRAWINGS

The accompanying drawings, which are included to provide a further understanding of the present disclosure and constitute a part of the detailed description, illustrate embodiments of the present disclosure and together with the description serve to explain the principle of the present disclosure.

FIG. 1 illustrates a 5G system architecture using a reference point representation.

FIG. 2 illustrates a radio protocol stack to which the present disclosure is applicable.

FIG. 3 is a flow chart illustrating a problem that may occur when only allowed NSSAI is included in an UCU COMMAND message.

FIG. 4 is a flow chart illustrating a problem that may occur when allowed NSSAI and (re-)registration request information/indication are included in an UCU COMMAND message.

FIG. 5 illustrates an UCU procedure according to invention proposal 1.

FIG. 6 illustrates an UCU procedure according to invention proposal 2.

FIG. 7 is a flow chart illustrating an UCU method of a UE according to an embodiment of the present disclosure.

FIG. 8 is a block diagram of a UE performing an UCU method according to an embodiment of the present disclosure.

FIG. 9 is a flow chart illustrating an UCU method of an AMF according to an embodiment of the present disclosure.

FIG. 10 is a block diagram of an AMF performing an UCU method according to an embodiment of the present disclosure.

FIG. 11 illustrates a block configuration diagram of a communication device according to an embodiment of the present disclosure.

FIG. 12 illustrates a block configuration diagram of a communication device according to an embodiment of the present disclosure.

### MODE FOR INVENTION

In what follows, preferred embodiments according to the present disclosure will be described in detail with reference to appended drawings. The detailed descriptions provided below together with appended drawings are intended only to explain illustrative embodiments of the present disclosure, which should not be regarded as the sole embodiments of the present disclosure. The detailed descriptions below include specific information to provide complete understanding of the present disclosure. However, those skilled in the art will be able to comprehend that the present disclosure can be embodied without the specific information.

For some cases, to avoid obscuring the technical principles of the present disclosure, structures and devices well-known to the public can be omitted or can be illustrated in the form of block diagrams utilizing fundamental functions of the structures and the devices.

A base station in this document is regarded as a terminal node of a network, which performs communication directly with a UE. In this document, particular operations regarded to be performed by the base station may be performed by a upper node of the base station depending on situations. In other words, it is apparent that in a network consisting of a plurality of network nodes including a base station, various operations performed for communication with a UE can be performed by the base station or by network nodes other than the base station. The term Base Station (BS) can be replaced with a fixed station, Node B, evolved-NodeB (eNB), Base Transceiver System (BTS), or Access Point (AP). Also, a terminal can be fixed or mobile; and the term can be replaced with User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, or Device-to-Device (D2D) device.

In what follows, downlink (DL) refers to communication from a base station to a terminal, while uplink (UL) refers to communication from a terminal to a base station. In downlink transmission, a transmitter can be part of the base station, and a receiver can be part of the terminal. Similarly, in uplink transmission, a transmitter can be part of the terminal, and a receiver can be part of the base station.

Specific terms used in the following descriptions are introduced to help understanding the present disclosure, and the specific terms can be used in different ways as long as it does not leave the technical scope of the present disclosure.

The technology described below can be used for various types of wireless access systems based on Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), or Non-Orthogonal Multiple Access (NOMA). CDMA can be implemented by such radio technology as Universal Terrestrial Radio Access (UTRA) or CDMA2000. TDMA can be implemented by such radio technology as Global System for Mobile communications (GSM), General Packet Radio Service (GPRS), or Enhanced Data rates for GSM Evolution (EDGE). OFDMA can be implemented by such radio technology as the IEEE 802.11 (Wi-Fi), the IEEE 802.16 (WiMAX), the IEEE 802-20, or Evolved UTRA (E-UTRA). UTRA is part of the Universal Mobile Telecommunications System (UMTS). The 3rd Generation Partnership Project (3GPP) Long Term Evolution (LTE) is part of the Evolved UMTS (E-UMTS) which uses the E-UTRA, employing OFDMA for downlink and SC-FDMA for uplink transmission. The LTE-A (Advanced) is an evolved version of the 3GPP LTE system.

Embodiments of the present disclosure can be supported by standard documents disclosed in at least one of wireless access systems including the IEEE 802, 3GPP, and 3GPP2 specifications. In other words, among the embodiments of the present disclosure, those steps or parts omitted for the purpose of clearly describing technical principles of the present disclosure can be supported by the documents above. Also, all of the terms disclosed in this document can be explained with reference to the standard documents.

To clarify the descriptions, this document is based on the 3GPP LTE/LTE-A, but the technical features of the present disclosure are not limited to the current descriptions.

Terms used in this document are defined as follows.
Universal Mobile Telecommunications System (UMTS): the 3rd generation mobile communication technology based on global system for mobile communication (GSM) developed by the 3GPP.
Evolved Packet System (EPS): a network system consisting of an evolved packet core (EPC), that is an internet protocol (IP) based packet switched core network, and an access network such as LTE and UTRAN. The EPS is a network of an evolved version of an UMTS.
NodeB: the base station of the UMTS network. NodeB is installed outside and provides coverage of a macro cell.
eNodeB: the base station of the EPS network. eNodeB is installed outside and provides coverage of a macro cell.
Home NodeB: It is installed indoors as a based station, and the coverage is a micro cell scale.
Home eNodeB: It is installed indoors as a base station of the EPS network, and the coverage is a micro cell scale.
User Equipment (UE): A UE can be called a terminal, Mobile Equipment (ME), or Mobile Station (MS). A UE can be a portable device such as a notebook computer, mobile phone, Personal Digital Assistant (PDA), smart phone, or a multimedia device; or a fixed device such as a Personal Computer (PC) or vehicle-mounted device. The term UE may refer to an MTC terminal in the description related to MTC.
Machine Type Communication (MTC): communication performed by machines without human intervention. It may be called Machine-to-Machine (M2M) communication.
MTC terminal (MTC UE or MTC device or MRT apparatus): a terminal (e.g., a vending machine, meter, and so on) equipped with a communication function (e.g., communication with an MTC server through PLMN) operating through a mobile communication network and performing the MTC functions.
Radio Access Network (RAN): a unit including a Node B, a Radio Network Controller (RNC) controlling the Node B, and an eNodeB in the 3GPP network. The RAN is defined at the terminal level and provides a connection to a core network.
Home Location Register (HLR)/Home Subscriber Server (HSS): a database provisioning subscriber information within the 3GPP network. An HSS can perform functions of configuration storage, identity management, user state storage, and so on.
Public Land Mobile Network (PLMN): a network formed to provide mobile communication services to individuals. The PLMN can be formed separately for each operator.
Non-Access Stratum (NAS): a functional layer for exchanging signals and traffic messages between a terminal and a core network at the UMTS and EPS protocol stack. The NAS is used primarily for supporting mobility of a terminal and a session management procedure for establishing and maintaining an IP connection between the terminal and a PDN GW.
Service Capability Exposure Function (SCEF): an entity in 3GPP architecture for the service capability exposure that provides a means for safely exposing a service and a capability provided by 3GPP network interface.
MME (Mobility Management Entity): A network node in an EPS network, which performs mobility management and session management functions
PDN-GW (Packet Data Network Gateway): A network node in the EPS network, which performs UE IP address allocation, packet screening and filtering, and charging data collection functions.
Serving GW (Serving Gateway): A network node in the EPS network, which performs functions such as mobility anchor, packet routing, idle mode packet buffering, and triggering paging for the ME of MME
Policy and Charging Rule Function (PCRF): A node in the EPS network, which performs policy decision to dynamically apply differentiated QoS and billing policies for each service flow
PDN (Packet DataNetwork): A network in which a server supporting a specific service (e.g., MMS server, WAP server, etc.) is located.
PDN connection: A connection from the UE to the PDN, that is, the association (connection) between the UE represented by the IP address and the PDN represented by the APN.

In what follows, the present disclosure will be described based on the terms defined above.

5G System Architecture to which the Present Disclosure is Applicable

A 5G system is a technology advanced from the 4th generation LTE mobile communication technology and a new radio access technology (RAT) through the evolution of the existing mobile communication network structure or a clean-state structure and an extended technology of long term evolution (LTE), and it supports extended LTE (eLTE), non-3GPP (e.g., WLAN) access and so on.

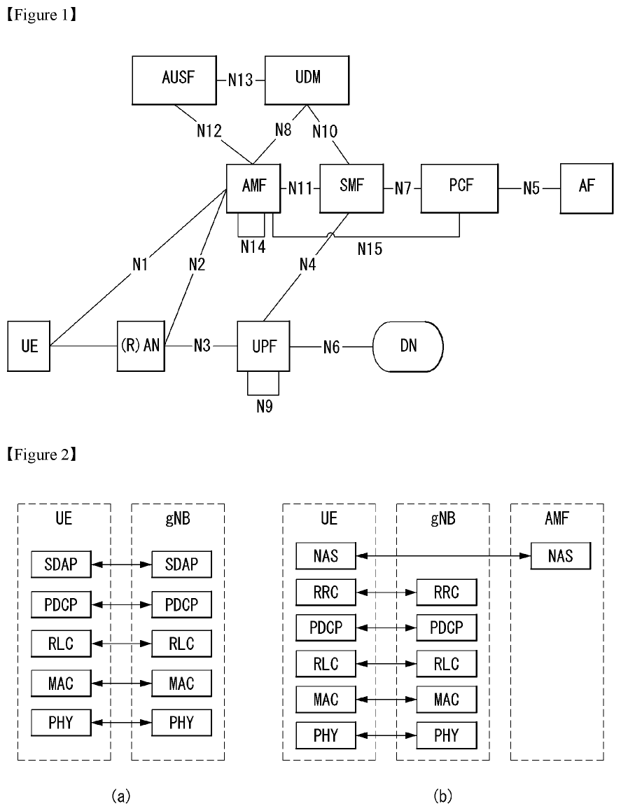

A 5G system is defined based on a service, and an interaction between network functions (NFs) within architecture for a 5G system may be expressed by two methods as follows.
Reference point representation (FIG. 1): indicates an interaction between NF services within NFs described by a point-to-point reference point (e.g., N11) between two NFs (e.g., AMF and SMF).
Service-based representation (FIG. 10): network functions (e.g., AMFs) within a control plane (CP) permit other authenticated network functions to access its own service. If this representation is necessary, it also includes a point-to-point reference point.

FIG. 1 is a diagram illustrating 5G system architecture using a reference point representation.

Referring to FIG. 1, the 5G system architecture may include various elements (i.e., a network function (NF)). This drawing illustrates an authentication server function (AUSF), a (core) access and mobility management function (AMF), a session management function (SMF), a policy control function (PCF), an application function (AF), united data management (UDM), a data network (DN), a user plane function (UPF), a (radio) access network ((R)AN) and a user equipment (UE) corresponding to some of the various elements.

Each of the NFs supports the following functions.
AUSF stores data for the authentication of a UE.
AMF provides a function for access of a UE unit and mobility management and may be basically connected to one AMF per one UE.

Specifically, the AMF supports functions, such as signaling between CN nodes for mobility between 3GPP access networks, the termination of a radio access network (RAN) CP interface (i.e., N2 interface), the termination (N1) of NAS signaling, NAS signaling security (NAS ciphering and integrity protection), AS security control, registration area management, connection management, idle mode UE reachability (including control and execution of paging retransmission), mobility management control (subscription and policy), intra-system mobility and inter-system mobility support, the support of network slicing, SMF selection, lawful interception (for an AMF event and an interface to an LI system), the provision of transfer of a session management (SM) message between a UE and an SMF, a transparent proxy for SM message routing, access authentication, access authorization including a roaming right check, the provision of transfer of an SMS message between a UE and an SMSF(SMS(Short Message Service) function), a security anchor function (SEA) and/or security context management (SCM).

Some or all of the functions of the AMF may be supported within a single instance of one AMF.
DN means an operator service, Internet access or a 3rd party service, for example. The DN transmits a downlink protocol data unit (PDU) to an UPF or receives a PDU, transmitted by a UE, from a UPF.
PCF provides a function for receiving information about a packet flow from an application server and determining a policy, such as mobility management and session management. Specifically, the PCF supports functions, such as the support of a unified policy framework for controlling a network behavior, the provision of a policy rule so that a CP function(s) (e.g., AMF or SMF) can execute a policy rule, and the implementation of a front end for accessing related subscription information in order to determine a policy within user data repository (UDR).
SMF provides a session management function and may be managed by a different SMF for each session if a UE has a plurality of sessions.

Specifically, the SMF supports functions, such as session management (e.g., session setup, modification and release including the maintenance of a tunnel between a UPF and an AN node), UE IP address allocation and management (optionally including authentication), the selection and control of the UP function, a traffic steering configuration for routing traffic from the UPF to a proper destination, the termination of an interface toward policy control functions, the execution of the control part of a policy and QoS, lawful interception (for an SM event and an interface to an LI system), the termination of the SM part of an NAS message, downlink data notification, the initiator of AN-specific SM information (transferred to an AN through N2 via the AMF), the determination of an SSC mode of a session, and a roaming function.

Some or all of the functions of the SMF may be supported within a single instance of one SMF.
UDM stores the subscription data of a user, policy data, etc. UDM includes two parts, that is, an application front end (FE) and user data repository (UDR).

The FE includes a UDM FE responsible for the processing of location management, subscription management and credential and a PCF responsible for policy control. The UDR stores data required for functions provided by the UDM-FE and a policy profile required by the PCF. Data stored within the UDR includes user subscription data, including a subscription ID, security credential, access and mobility-related subscription data and session-related subscription data, and policy data. The UDM-FE supports functions, such as access to subscription information stored in the UDR, authentication credential processing, user identification handling, access authentication, registration/mobility management, subscription management, and SMS management.
UPF transfers a downlink PDU, received from a DN, to a UE via an (R)AN and transfers an uplink PDU, received from a UE, to a DN via an (R)AN.

Specifically, the UPF supports functions, such as an anchor point for intra/inter RAT mobility, the external PDU session point of interconnection to a data network, packet routing and forwarding, a user plane part for the execution of packet inspection and a policy rule, lawful interception, a traffic usage report, an uplink classifier for supporting the routing of traffic flow of a data network, a branching point for supporting a multi-home PDU session, QoS handling (e.g., the execution of packet filtering, gating and an uplink/downlink rate) for a user plane, uplink traffic verification (SDF mapping between a service data flow (SDF) and a QoS flow), transport level packet marking within the uplink and downlink, downlink packet buffering, and a downlink data notification triggering function. Some or all of the functions of the UPF may be supported within a single instance of one UPF.
AF interoperates with a 3GPP core network in order to provide services (e.g., support functions, such as an application influence on traffic routing, network capability exposure access, an interaction with a policy framework for policy control).
(R)AN collectively refers to a new radio access network supporting all of evolved E-UTRA (E-UTRA) and new radio (NR) access technologies (e.g., gNB), that is, an advanced version of the 4G radio access technology.

The network node in charge of transmission/reception of wireless signals with the UE is the gNB, and plays the same role as the eNB.

The gNB supports functions for radio resource management (i.e., radio bearer control and radio admission control), connection mobility control, the dynamic allocation (i.e., scheduling) of resources to a UE in the uplink/downlink, Internet protocol (IP) header compression, the encryption and integrity protection of a user data stream, the selection of an AMF upon attachment of a UE if routing to the AMF has not been determined based on information provided to the UE, the selection of an AMF upon attachment of a UE, user plane data routing to an UPF(s), control plane information routing to an AMF, connection setup and release, the scheduling and transmission of a paging message (generated from an AMF), the scheduling and transmission of system broadcast information (generated from an AMF or operation and maintenance (O&M)), a measurement and measurement report configuration for mobility and scheduling, transport level packet marking in the uplink, session management, the support of network slicing, QoS flow management and mapping to a data radio bearer, the support of a UE that is an inactive mode, the distribution function of an NAS message, an NAS node selection function, radio access network sharing, dual connectivity, and tight interworking between an NR and an E-UTRA.
UE means a user device. A user apparatus may be called a term, such as a terminal, a mobile equipment (ME) or a mobile station (MS). Furthermore, the user apparatus may be a portable device, such as a notebook, a mobile phone, a personal digital assistant (PDA), a smartphone or a multimedia device, or may be a device that cannot be carried, such as a personal computer (PC) or a vehicle-mounted device.

In the drawings, for the clarity of description, an unstructured data storage network function (UDSF), a structured data storage network function (SDSF), a network exposure function (NEF) and an NF repository function (NRF) are not shown, but all of the NFs shown in this drawing may perform mutual operations along with the UDSF, NEF and NRF, if necessary.
NEF provides means for safely exposing services and capabilities provided by 3GPP network functions, for example, for a 3rd party, internal exposure/re-exposure, an application function, and edge computing. The NEF receives information from other network function(s) (based on the exposed capability(s) of other network function(s)). The NEF may store information received as structured data using a standardized interface as a data storage network function. The stored information is re-exposed to other network function(s) and application function(s) by the NEF and may be used for other purposes, such as analysis.
NRF supports a service discovery function. It receives an NF discovery request from an NF instance and provides information of a discovered NF instance to an NF instance. Furthermore, it maintains available NF instances and services supported by the available NF instances.
SDSF is an optional function for supporting a function of storing and retrieving information as structured data by any NEF.
UDSF is an optional function for supporting a function of storing and retrieving information as unstructured data by any NF.

In the 5G system, a node which is responsible for wireless transmission/reception with the UE is gNB and plays the same role as the eNB in the EPS. When the UE is simultaneously connected to the 3GPP connection and the non-3GPP connection, the UE receives a service through one AMF as illustrated in FIG. 1. In FIG. 1, it is illustrated that a connection is made by the non-3GPP connection and a connection is made by the 3GPP connection are connected to one same UPF, but the connection is not particularly required and may be connected by a plurality of different UPFs.

However, when the UE selects N3IWK (also referred to as non-3GPP interworking function (N3IWF)) in the HPLMN in the roaming scenario and is connected to the non-3GPP connection, the AMF that manages the 3GPP connection may be located in the VPLMN and the AMF that manages the non-3GPP connection may be located in the HPLMN.

The non-3GPP access network is connected to the 5G core network via N3IWK/N3IWF. The N3IWK/N3IWF interfaces the 5G core network control plane function and user plane function via the N2 and N3 interfaces, respectively.

A representative example of the non-3GPP connection mentioned in the present disclosure may be a WLAN connection.

Meanwhile, this drawing illustrates a reference model if a UE accesses one DN using one PDU session, for convenience of description, but the present disclosure is not limited thereto.

A UE may access two (i.e., local and central) data networks at the same time using multiple PDU sessions. In this case, for different PDU sessions, two SMFs may be selected. In this case, each SMF may have the ability to control both a local UPF and central UPF within a PDU session, which can be independently activated per PDU.

Furthermore, a UE may access two (i.e., local and central) data networks provided within one PDU session at the same time.

In the 3GPP system, a conceptual link that connects NFs within the 5G system is defined as a reference point. The following illustrates reference points included in 5G system architecture represented in this drawing.
N1: a reference point between a UE and an AMF
N2: a reference point between an (R)AN and an AMF
N3: a reference point between an (R)AN and a UPF
N4: a reference point between an SMF and a UPF
N5: a reference point between a PCF and an AF
N6: a reference point between a UPF and a data network
N7: a reference point between an SMF and a PCF
N24: a reference point between a PCF within a visited network and a PCF within a home network
N8: a reference point between a UDM and an AMF
N9: a reference point between two core UPFs
N10: a reference point between a UDM and an SMF
N11: a reference point between an AMF and an SMF
N12: a reference point between an AMF and an AUSF
N13: a reference point between a UDM and an authentication server function (AUSF)
N14: a reference point between two AMFs
N15: a reference point between a PCF and an AMF in the case of a non-roaming scenario and a reference point between a PCF within a visited network and an AMF in the case of a roaming scenario
N16: a reference point between two SMFs (in the case of a roaming scenario, a reference point between an SMF within a visited network and an SMF within a home network)
N17: a reference point between an AMF and an EIR
N18: a reference point between any NF and an UDSF
N19: a reference point between an NEF and an SDSF

Radio Protocol Architecture

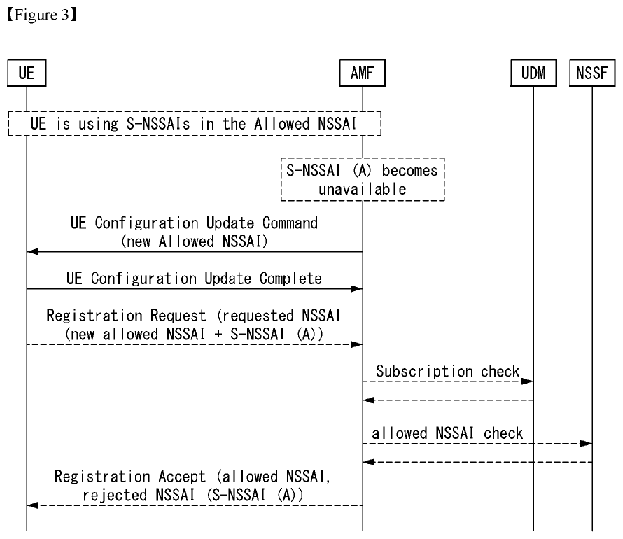

FIG. 2 illustrates a radio protocol stack to which the present disclosure is applicable. Specifically, FIG. 2(a) illustrates a radio interface user plane protocol stack between a UE and a gNB, and FIG. 2(b) illustrates a radio interface control plane protocol stack between the UE and the gNB.

A control plane means a passage through which control messages are transmitted in order for a UE and a network to manage a call. A user plane means a passage through which data generated in an application layer, for example, voice data or Internet packet data is transmitted.

Referring to FIG. 2(a), the user plane protocol stack may be divided into a first layer (Layer 1) (i.e., a physical layer (PHY) layer) and a second layer (Layer 2).

Referring to FIG. 2(b), the control plane protocol stack may be divided into a first layer (i.e., a PHY layer), a second layer, a third layer (i.e., a radio resource control (RRC) layer) and a non-access stratum (NAS) layer.

The second layer is divided into a medium access control (MAC) sublayer, a radio link control (RLC) sublayer, a packet data convergence protocol (PDC) sublayer, and a service data adaptation protocol (SDAP) sublayer (in the case of a user plane).

Radio bearers are classified into two groups: a data radio bearer (DRB) for user plane data and a signaling radio bearer (SRB) for control plane data

Hereinafter, the layers of the control plane and user plane of the radio protocol are described.

1) The PHY layer, that is, the first layer, provides information transfer service to a higher layer using a physical channel. The PHY layer is connected to the MAC sublayer located in a high level through a transport channel. Data is transmitted between the MAC sublayer and the PHY layer through a transport channel. The transport channel is classified depending on how data is transmitted according to which characteristics through a radio interface. Furthermore, data is transmitted between different physical layers, that is, between the PHY layer of a transmission stage and the PHY layer of a reception stage through a physical channel.

2) The MAC sublayer performs mapping between a logical channel and a transport channel; the multiplexing/demultiplexing of an MAC service data unit (SDU) belonging to one logical channel or different logical channels to/from a transport block (TB) transferred to/from the PHY layer through a transport channel; a scheduling information report; error correction through a hybrid automatic repeat request (HARQ); priority handling between UEs using dynamic scheduling; priority handling between the logical channels of one UE using logical channel priority; and padding.

Different types of data transfer service provided by the MAC sublayer. Each logical channel type defines that information of which type is transferred.

Logical channels are classified into two groups: a control channel and a traffic channel.

i) The control channel is used to transfer only control plane information and is as follows.
Broadcast control channel (BCCH): a downlink channel system for broadcasting control information.
Paging control channel (PCCH): a downlink channel transferring paging information and system information change notification.
Common control channel (CCCH): a channel for transmitting control information between a UE and a network. This channel is used for UEs not having an RRC connection with a network.
Dedicated control channel (DCCH): a point-to-point bidirectional channel for transmitting dedicated control information between a UE and a network. It is used by a UE having an RRC connection.

ii) The traffic channel is used to use only user plane information:
Dedicated traffic channel (DTCH): a point-to-point channel for transferring user information and dedicated to a single UE. The DTCH may be present in both the uplink and downlink.

In the downlink, a connection between a logical channel and a transport channel is as follows.

A BCCH may be mapped to a BCH. A BCCH may be mapped to a DL-SCH. A PCCH may be mapped to a PCH. A CCCH may be mapped to a DL-SCH. A DCCH may be mapped to a DL-SCH. A DTCH may be mapped to a DL-SCH.

In the uplink, a connection between a logical channel and a transport channel is as follows. A CCCH may be mapped to an UL-SCH. A DCCH may be mapped to anUL-SCH. A DTCH may be mapped to an UL-SCH.

3) The RLC sublayer supports three transport modes: a transparent mode (TM), an unacknowledged mode (UM) and acknowledged mode (AM).

An RLC configuration may be applied to each logical channel. In the case of an SRB, the TM or AM mode is used. In contrast, in the case of a DRB, the UM or AM mode is used.

The RLC sublayer performs the transfer a higher layer PDU; independent sequence numbering with a PDCP; error correction through an automatic repeat request (ARW); segmentation and re-segmentation; the reassembly of an SDU; RLC SDU discard; and RLC re-establishment.

4) The PDCP sublayer for a user plane performs sequence numbering; header compression and compression-decompression (corresponding to only robust header compression (RoHC)); user data transfer; reordering and duplicate detection (if there is transfer to a layer higher than the PDCP); PDCP PDU routing (in the case of a split bearer); the retransmission of a PDCP SDU; ciphering and deciphering; PDCP SDU discard; PDCP re-establishment and data recovery for RLC AM; and the duplication of a PDCP PDU.

The PDCP sublayer a control plane additionally performs sequence numbering; ciphering, deciphering and integrity protection; control plane data transfer; duplication detection; the duplication of a PDCP PDU.

When duplication for a radio bearer is configured by RRC, an additional RLC entity and an additional logical channel are added to a radio bearer in order to control a duplicated PDCP PDU(s). In the PDCP, duplication includes transmitting the same PDCP PDU(s) twice. The first one is transferred to the original RLC entity, and the second one is transferred to an additional RLC entity. In this case, the duplication corresponding to the original PDCP PDU is not transmitted to the same transport block. Different two logical channels may belong to the same MAC entity (in the case of a CA) or to different MAC entities (in the case of DC). In the former case, a logical channel mapping restriction is used to guarantee that a duplication corresponding to the original PDCP PDU is not transferred to the same transport block.

5) The SDAP sublayer performs i) mapping between a QoS flow and a data radio bearer and ii) QoS flow ID marking within a downlink and uplink packet.

One protocol entity of an SDAP is configured for each PDU session, but exceptionally in the case of dual connectivity (DC), two SDAP entities may be configured.

6) The RRC sublayer performs the broadcasting of system information related to an access stratum (AS) and a non-access stratum (NAS); paging initiated by 5GC or an NG-RAN; the establishment, maintenance and release (additionally including the modification and release of a carrier aggregation and additionally including the modification and release of dual connectivity between an E-UTRAN and an NR or within an NR) of an RRC connection between a UE and an NG-RAN; a security function including key management; the establishment, configuration, maintenance and release of an SRB(s) and a DRB(s); handover and context transfer; control of UE cell selection, re-release and cell selection/reselection; a mobility function including mobility between RATs; a QoS management function, a UE measurement report and report control; the detection of a radio link failure and recovery from a radio link failure; and the transfer of an NAS message from an NAS to a UE and the transfer of an NAS message from a UE to an NAS.

Network Slicing

The 5G system has introduced a network slicing technology providing network resources and network functions as individual slices according to each service.

A network slice is a complete logical network that includes a set of network functions and corresponding resources required to provide specific network functions and network characteristics. Both 5G-AN and 5G CN are included in the network slice. A network slice instance (NSI) refers to the instantiation of a network slice, i.e., a deployed set of network functions delivering the intended network slice services according to a network slice template.

With the introduction of network slicing, isolation, independent management, etc. of network functions and network resources can be provided for each slice. Hence, the network slicing can select and combine network functions of the 5G system according to services, users, etc., thereby providing services that are independent for each user and are more flexible.

The network slice refers to a network that logically integrates an access network and a core network.

The network slice may include one or more of the followings:
core network control plane and user plane functions
NG-RAN
non-3GPP interworking function (N3IWF) to non-3GPP access network

Supported features and network function optimization may differ for each network slice. Multiple network slice instances may provide the same function for different groups of UEs.

One UE may be connected to one or more network slice instances at the same time via a 5G-AN. The one UE may be served by up to eight network slices at the same time. An AMF instance serving the UE may belong to each network slice instance serving the UE. That is, the AMF instance may be common to the network slice instance serving the UE. The CN part of the network slice instance(s) serving the UE is selected by the CN.

The AMF search and selection for a set of slices for the UE are triggered by the first contacted AMF in a registration procedure, and this can lead to a change of AMF. The SMF search and selection are initiated by the AMF when a SM message for establishing the PDU session is received from the UE. The NRF is used to help search and selection operations.

One PDU session belongs to only one specific network slice instance per PLMN. Different network slice instances do not share the one PDU session.

One PDU session belongs to one specific network slice instance per PLMN. Different slices may have slice-specific PDU sessions using the same data network name (DNN), but different network slice instances do not share one PDU session.

Single network slice selection assistance information (S-NSSAI) identifies a network slice. Each S-NSSAI is assistance information used for a network to select a specific network slice instance. NSSAI is a set of S-NSSAI(s). The S-NSSAI includes the followings:
Slice/service type (SST): it refers to the expected network slice behavior in terms of features and services.
Slice Differentiator (SD): it is optional information that complements the SST to differentiate among multiple network slices of the same slice/service type.

The S-NSSAI may have standard values or PLMN-specific values. The S-NSSAI with the PLMN-specific value is associated with a PLMN ID of the PLMN allocating the PLMN-specific values. The S-NSSAI shall not be used by the UE in an access stratum procedure in any PLMN other than the one to which the S-NSSAI is associated.

1) Network Slice Selection Upon Initial Access

A UE may be configured with a configured NSSAI per PLMN by home PLMN (HPLMN). The configured NSSAI is PLMN-specific, and the HPLMN indicates PLMN(s) to which each configured NSSAI is applied.

Upon initial access of the UE, an RAN selects an initial network slice which will send a message using the NSSAI. To this end, in a registration procedure, the UE provides a requested NSSAI to the network. When the UE provides the requested NSSAI to the network, the UE within a predetermined PLMN uses only S-NSSAIs belonging to the configured NSSAI of a corresponding PLMN.

If the UE does not provide the NSSAI to the RAN or the RAN does not select a proper network slice according to the provided NSSAI, the RAN may select a default network slice.

Subscription data includes S-NSSAI(s) of network slice(s) to which the UE subscribes. One or more S-NSSAIs may be marked as default S-NSSAI. If the S-NSSAI is marked as default, the network can serve the UE with the related network slice even when the UE does not send any S-NSSAI to the network in a registration request. UE subscription data may include a default DNN for a given S-NSSAI. The NSSAI that the UE provides in the registration request is verified for user's subscription data.

If the UE is successfully registered, a CN informs (R)AN by providing the whole allowed NSSAI (including one or more S-NSSAIs). Further, when a registration procedure of the UE is successfully completed, the UE may obtain the allowed NSSAI for this PLMN from the AMF.

The allowed NSSAI takes precedence over the configured NSSAI for this PLMN. The UE uses only the S-NSSAI(s) in the allowed NSSAI corresponding to a network slice for a subsequent network slice selection related procedure in the serving PLMN.

For each PLMN, the UE stores the configured NSSAI and the Allowed NSSAI (if any). When the UE receives an Allowed NSSAI for a PLMN, it overrides a previously stored allowed NSSAI for this PLMN.

2) Slice Change

The network can change an already selected network slice instance according to a local policy, UE mobility, change in subscription information, etc. That is, a set of network slices for the UE can be changed at any time while the UE is registered with the network. Further, change in the set of network slices for the UE may be initiated by the network or the UE under specific conditions.

Based on a local policy, change in subscription information, and/or UE mobility, the network may change a set of allowed network slice(s) to which the UE is registered. The network may perform such change during a registration procedure or notify the UE of change in supported network slice(s) using a procedure which can trigger a registration procedure.

Upon the change of the network slice, the Network may provide the UE with a new allowed NSSAI and a tracking area list. The UE includes anew NSSAI in signaling according to a mobility management procedure to transmit it and thus causes reselection of a slice instance. According to the change of the network slice, an AMF supporting this may be changed.

If the UE enters an area where a network slice is no longer available, a core network releases PDU sessions for an S-NSSAI corresponding to a network slice that is no longer available via a PDU session release procedure.

When the PDU sessions corresponding to a slice that is no longer available are released, the UE uses a UE policy to determine whether an existing traffic can be routed over PDU sessions belonging to other slices.

In order to change a set of S-NSSAI(s) being used, the UE initiates a registration procedure.

3) SMF Selection

A PCF provides a network slice selection policy (NSSP) to the UE. The NSSP associates the UE with an S-NSSAI and is used by the UE so as to determine PDU sessions when a traffic is routed.

The NSSP is provided per application of the UE, and it includes a rule capable of mapping the S-NSSAI per UE application. An AMF selects a SMF for PDU session management using subscription information, a local provider policy, etc. together with SM-NSSAI and DNN information delivered by the UE.

When a PDU session for a specific slice instance is established, the CN provides the (R)AN with the S-NSSAI corresponding to the slice instance to which the PDU session belongs so that the RAN can access a specific function of the slice instance.

4) UE NSSAI Configuration and NSSAI Storage Aspect

A UE may be configured by the HPLMN with NSSAI. This is defined as configured-NSSAI. The configured-NSSAI may be PLMN-specific as long as it is not configured with only a standard S-NSSAI value. A PLMN ID of the configured-NSSAI does not need to be specific if the UE is applied to all the PLMNs that can be roamed. The UE may be configured with NSSAI for several PLMNs.

If a registration procedure of the UE is successfully completed, the UE can obtain the NSSAI from the AMF, and the NSSAI may include one or more S-NSSAIs to be used by the UE for the purpose of a subsequent slice selection related procedure. This is referred to as accepted NSSAI.

The UE shall store accepted NSSAI for each PLMN. The UE shall use the accepted NSSAI when the UE returns to the PLMN.

5) Detailed Operation Overview

When a UE registers with a PLMN, if it is stored in the UE, the UE shall provide the network in RRC and NAS layer with configured-NSSAI, accepted NSSAI, or a subset thereof.

It may be determined whether NSSAI of the RRC and NSSAI of the NAS layer are exactly the same. While NSSAI is used to select an AMF, S-NSSAI is used to help a network slice instance selection.

The UE shall store configured and/or accepted NSSAI for each PLMN.
the configured-NSSAI is configured to the UE by HPLMN so that when PLMN-specific accepted NSSAI is not stored in the UE, it is used in PLMN.
the accepted NSSAI is NSSAI that is provided to the UE by PLMN in a registration procedure, and the UE shall use it in the corresponding PLMN from the corresponding PLMN to a next registration, A registration accept message may include accepted NSSAI. The accepted NSSAI may be updated by a subsequent registration procedure.

If the UE has been provided with the configured-NSSAI for the selected PLMN, the UE shall include this NSSAI in RRC connection establishment and NAS. The RAN routes an initial access to the AMF using the provided NSSAI.

If the UE has not yet received any accepted NSSAI for the selected PLMN, but has been provided with configured-NSSAI for the selected PLMN, the UE may provide RRC connection establishment and NSSAI or sub-set configured in NAS. The RAN uses NSSAI to route an initial access for the AMF.

If the UE does not provide any (accepted or configured) NSSAI for the RRC connection establishment and PLMN selected in the NAS, the RAN transmits NAS signalling to a default AMF.

If registration is successfully performed, the UE is provided with a globally unique temporary UE identity (GUTI) by a serving AMF. The UE includes a local unique temporary ID in the RRC connection establishment during a subsequent initial access so that the RAN in which a Temp ID is available can route a NAS message to a proper AMF. Further, a serving PLMN may return a recently accepted NSSAI of slices allowed by the serving PLMN for the UE. The accepted NSSAI includes S-NSSAI values of slices allowed by the serving PLMN of the UE.

When the RRC receives NSSAI and a complete local unique temporary ID, the RAN reaches an AMF corresponding to a locally unique temporary ID, the RAN sends a request to the corresponding AMF. Otherwise, the RAN selects a proper AMF based on the NSSAI provided by the UE and sends the request to the selected AMF. If the RAN cannot select the AMF based on the provided NSSAI, the request is sent to a default AMF.

A network operator may provide the UE with a network slice selection policy (NSSP). The NSSP includes one or more NSSP rules, each of which associates one application with specific S-NSSAI. The NSSP may include a default rule that matches all applications to S-NSSAI. When a UE application associated with the specific S-NSSAI requests data transmission:
if the UE has one or more PDU sessions established with the specific S-NSSAI, the UE routes user data of this application in one of the corresponding PDU sessions, unless other conditions of the UE prohibit the use of the PDU sessions. If the application provides a DNN, the UE considers this DNN to determine which PDU session to use.

If the UE does not have a PDU session established with this specific S-NSSAI, the UE requests a new PDU Session corresponding to this S-NSSAI and a DNN that may be provided by the application. In order for the RAN to select a proper resource for supporting network slicing in the RAN, the RAN needs to be aware of the network slices used by the UE.

Based on a local policy, change in subscription information, and/or UE mobility, the network can change a set of network slices used by the UE by providing the UE with an accepted NSSAI change notification representing a new value of NSSAI. This triggers, to RRC and NAS signalling, a UE-initiation re-registration including a new value of NSSAI provided by the network.

The change in a set of slices used by the UE (whether to initiate the UE or the network) may cause the AMF change depending on an operator policy.

If the UE changes a set of network slices that the UE can access, when these slices are no longer used (when some slices are potentially maintained), a set of original network slices and ongoing PDU sessions end.

During an initial registration procedure, if the network decides that the UE should be served by a different AMF, the AMF that first receives an initial registration request may redirect the initial registration request to another AMF via the RAN or via direct signalling between an initial AMF and a target AMF. A redirection message sent by the AMF via the RAN shall include information for a new AMF to serve the UE.

For a UE that is already registered, the system shall support a redirection initiated by the network of the UE from its serving AMF to a target AMF.
Operator policy determines whether redirection between AMFs is allowed.
If the network decides to redirect the UE due to NSSAI change, the network transmits updated/new NSSAI to the UE using a RM procedure, and the UE sends an indication to start a registration update procedure with the updated/new NSSAI. The UE initiates the registration update procedure with the updated/new NSSAI.

The ANF selects a SMF in a network slice instance based on S-NSSAI, DNN and other information (e.g., UE subscription and local operator policy). The selected SMF establishes PDU sessions based on S-NSSAI and DNN.

In a roaming scenario, network slice specific network functions of VPLMN and HPLMN are selected as follows based on S-NSSAI provided by the UE during a PDU connection establishment:
if standardized S-NSSAI is used, the selection of a slice specific NF instance is performed by each PLMN based on provided S-NSSAI.
Otherwise, VPLMN maps S-NSSAI of HPLMN to S-NSSAI of VPLMN based on a roaming agreement (including mapping for default S-NSSAI of VPLMN). The selection of a slice specific NF instance in VPLMN is based on S-NSSAI of VPLMN, and the selection of a slice specific NF instance in HPLMN is based on S-NSSAI of HPLMN

The UE includes NSSAI values (in a registration request message) for network slice (hereinafter, NS) selection in a registration (corresponding to a related art attach or tracking area update process) process/procedure. Single NSSAI (S-NSSAI) representing one service may include slice/service type (SST) (e.g., V2X, IoT, eMBB) and slice differentiator (SD) (e.g., service provider). If the network is in a state of not receiving a valid Temp ID (e.g., GUTI), the network chooses a first contacting AMF based on this NSSAL. The decision of this common control network function (CCNF) may first determine routing in RAN based on NSSAI, and may send a query to a network slice selection function (NSSF) or a network repository function (NRF), etc. in the corresponding AMF to redirect to other AMF.

Multiple S-NSSAIs may be included in the following set:
Configured NSSAI: a set of configured S-NSSAIs by the UE in the corresponding PLMN.
Allowed NSSAI: a set of S-NSSAIs that the network actually allows to the UE upon registration accept.
Requested NSSAI: a set of S-NSSAIs that the UE requests through a registration request, it may be configured, allowed NSSAI and/or a subset thereof.

If there is allowed NSSAI previously received from the network, the UE may include, in requested NSSAI, at least one S-NSSAI belonging to configured NSSAI and/or allowed NSSAI. If there is no allowed NSSAI, the UE may include S-NSSAI, that is present in the configured NSSAI, in the requested NSSAI. The network goes through procedures such as subscription information check/authorization for the requested NSSAI, and then transmits, to the UE, a set of S-NSSAIs available for the UE as the allowed NSSAI. In this instance, the allowed NSSAI may include NSSAI value that is not included in the requested NSSAI.

The UE may receive S-NSSAI values that are usable in a current registration area and are allowed from the network via the request of requested NSSAI and the reception of allowed NSSAI through the most recent registration procedure. The UE may use only S-NSSAI included in the allowed NSSAI that is most recently received until performing a next registration procedure.

UE Configuration Update Procedure

The purpose of this procedure is to allow the AMF to update UE configuration by providing new parameter information within a command or requesting the UE to perform a mobility and periodic registration update procedure with the network to update parameters

This procedure may be initiated by the network and can be used only when the UE establishes a 5GMM context and the UE is in a 5GMM-CONNECTED mode. The AMF may require an acknowledgement response in order to ensure that the parameter has been updated by the UE.

The following parameters are supported by a generic UE configuration update procedure without the need for triggering the UE to perform the mobility and periodic registration update procedure:

a) 5G-GUTI;

b) TAI list;

c) Service area list;

d) Network ID and time zone information (full name for network, short name for network, local time zone, universal time, and network daylight saving time); and

e) LADN information;

The following parameters may trigger the UE to perform a registration update procedure:

a) Allowed NSSAI.

The following parameters require triggering the UE to perform the mobility and periodic registration update procedure:

a) MICO (Mobile Initiated Connection Only); and

b) Configured NSSAI.

The AMF shall initiate a generic UE configuration procedure by sending a CONFIGURATION UPDATE COMMAND message to the UE.

The AMF shall perform one or more of the following in the CONFIGURATION UPDATE COMMAND message:

a) include one or more of 5G-GUTI, TAI list, allowed NSSAI, LADN information, service area list, MICO indication, NITZ information, or configured NSSAI;

b) indicate registration requested; or

c) a combination of both.

If an acknowledgement from the UE is requested, the AMF shall indicate acknowledgement requested in a configuration update indication information element (IE) in the CONFIGURATION UPDATE COMMAND message and shall start timer T3555. The acknowledgement shall be requested for all parameters except when only NITZ is included.

To initiate parameter re-negotiation between the UE and the network, the AMF shall indicate “registration requested” in the configuration update indication IE in the CONFIGURATION UPDATE COMMAND message. In this case, the acknowledgement shall be requested.

If new allowed NSSAI information or AMF re-configuration of supported S-NSSAIs requires an AMF relocation, the AMF shall indicate “registration requested” in the configuration update indication IE and include the Allowed NSSAI IE in the CONFIGURATION UPDATE COMMAND message. In this case, the acknowledgement shall be requested.

If the AMF includes the configured NSSAI in the CONFIGURATION UPDATE COMMAND message, the AMF shall indicate “registration requested” in the configuration update indication IE in the message.

The CONFIGURATION UPDATE COMMAND message shall not include both new allowed NSSAI information and new configured NSSAI information.

During an established 5GMM context, the network may send none or one or more CONFIGURATION UPDATE COMMAND messages to the UE. If two or more CONFIGURATION UPDATE COMMAND messages are sent, the messages need not have the same content.

Upon receiving the CONFIGURATION UPDATE COMMAND message, the UE shall use the contents to update appropriate information stored within the UE.

If acknowledgement requested is indicated in the configuration update indication IE in the CONFIGURATION UPDATE COMMAND message: and

a) if all information elements included are successfully accepted by the UE; or

b) if “registration requested” in the configuration update indication IE is indicated;

the UE shall send a CONFIGURATION UPDATE COMPLETE message.

If the UE receives a new 5G-GUTI in the CONFIGURATION UPDATE COMMAND message, the UE considers the new 5G-GUTI as valid and the old 5G-GUTI as invalid; otherwise, the UE considers the old 5G-GUTI as valid.

If the UE receives a new TAI list in the CONFIGURATION UPDATE COMMAND message, the UE shall consider the new TAI list as valid and the old TAI list as invalid; otherwise, the UE shall consider the old TAI list as valid.

If the UE receives a new service area list in the CONFIGURATION UPDATE COMMAND message, the UE considers the new service area list as valid and the old service area list as invalid; otherwise, the UE considers the old service area list (if any) as valid.

If the UE receives new NITZ information in the CONFIGURATION UPDATE COMMAND message, the UE considers the new NITZ information as valid and the old NITZ information as invalid; otherwise, the UE shall consider the old NITZ information as valid.

If the UE receives new LADN information in the CONFIGURATION UPDATE COMMAND message, the UE considers the new LADN information as valid and the old LADN information as invalid; otherwise, the UE shall consider the old LADN information as valid.

If the UE receives a MICO indication and an indication for “registration requested” in the configuration update indication IE of the CONFIGURATION UPDATE COMMAND message, the UE shall send a REGISTRATION REQUEST message to re-negotiate a MICO mode with the network. If there is anew allowed NSSAI in the CONFIGURATION UPDATE COMMAND message, the UE shall send a REGISTRATION REQUEST message after releasing the existing NAS signalling connection for updating the allowed NSSAI, and re-negotiate the MICO mode with the network.

If the UE receives a new allowed NSSAI in the CONFIGURATION UPDATE COMMAND message, the UE considers the new allowed NSSAI as valid, stores the allowed NSSAI, and considers the old allowed NSSAI as invalid; otherwise, the UE shall consider the old Allowed NSSAI as valid.

If the UE receives an allowed NSSAI in the CONFIGURATION UPDATE COMMAND message and the UE has one or more PDU session contexts associated with S-NSSAI(s) that is not included in the received allowed NSSAI, the UE may locally release all such PDU session context(s).

If the UE receives a new configured NSSAI in the CONFIGURATION UPDATE COMMAND message, the UE considers the new configured NSSAI for the registered PLMN as valid and the old configured NSSAI for the registered PLMN as invalid; otherwise, the UE shall consider the old configured NSSAI for the registered PLMN as valid. In this case, the UE shall delete the stored allowed NSSAI and perform a mobility registration update procedure to obtain anew allowed NSSAI.

If the CONFIGURATION UPDATE COMMAND indicates “registration requested” in the configuration update indication IE and a new allowed NSSAI is included, the UE shall set the 5G-GUTI as invalid and wait for until the network releases the N1 NAS signalling connection prior to the registration. An update procedure is performed using a subscriber permanent identifier (SUPI) and including the new allowed NSSAI in the requested NSSAI. When the NAS signalling connection is released, the UE shall locally deactivate the PDU session(s) context. At a successful registration update, the UE should re-establish any previously activated PDU sessions. If the UE was registered over both 3GPP access and non-3GPP access with the same PLMN, the UE should register again over both 3GPP access and non-3GPP access on the same PLMN. In this case, the UE should first register over the 3GPP access.

Upon receipt of the CONFIGURATION UPDATE COMPLETE message, the AMF shall stop the timer T3555.

If a new 5G-GUTI is included in the CONFIGURATION UPDATE COMMAND message, the AMF considers the new 5G-GUTI as valid and the old 5G-GUTI as invalid.

If anew TAI list is included in the CONFIGURATION UPDATE COMMAND message, the AMF considers the new TAI list as valid and the old TAI list as invalid.

If a new service area list is included in the CONFIGURATION UPDATE COMMAND message, the AMF considers the new service area list as valid and the old service area list as invalid.

If new allowed NSSAI information is included in the CONFIGURATION UPDATE COMMAND message, the AMF shall consider the new allowed NSSAI information as valid and the old allowed NSSAI information as invalid.

If new LADN information is included in the CONFIGURATION UPDATE COMMAND message, the AMF shall consider the new LADN information as valid and the old LADN information as invalid. In addition, if registration requested is indicated in the CONFIGURATION UPDATE COMMAND message, the AMF shall release the N1 NAS signalling connection.

Before the UE starts a registration procedure, the network may need to update allowed NSSAI to the UE. For example, the network may prevent specific S-NSSAI that has been previously allowed from being used anymore, allow S-NSSAI that has not been previously allowed, replace S-NSSAI that has been previously used with other S-NSSAI, or temporarily limit the use of specific allowed S-NSSAI.

So far, as described in the standard, in order to update allowed NSSAI of the UE, the network may use a UE configuration update (hereinafter referred to as UCU) procedure for new allowed NSSAI. More specifically, the network may transmit updated allowed NSSAI to the UE using the UCU procedure. If the UE is in a CM-IDLE state, the network may transition a CM state of the UE to CM-CONNECTED through a paging and service request procedure, and then may update the allowed NSSAI through the UCU procedure. In this instance, the network may update the allowed NSSAI of the UE through one of the following operations.

1) including only allowed NSSAI in an UCU COMMAND message (e.g., CONFIGURATION UPDATE COMMAND message)
In this case, the UE considers allowed NSSAI that is newly received/updated from the network as valid, uses this value until the next registration, and sends an UCU COMPLETE message as a response to this. In this instance, the UE may not perform a separate CM mode transition or a registration procedure.

2) including allowed NSSAI and “(re-)registration requested” information/indication in the UCU COMMAND message (e.g., CONFIGURATION UPDATE COMMAND message)
The UE validly stores allowed NSSAI that is newly received/updated from the network, and sends the UCU COMPLETE message. The network may release NAS signalling connection in order to transition the CM state for the UE to the IDLE state. The UE starts the registration procedure as soon as the UE is in the CM-IDLE state. In this instance, the requested NSSAI requested by the UE may include the allowed NSSAI received from the network immediately before.

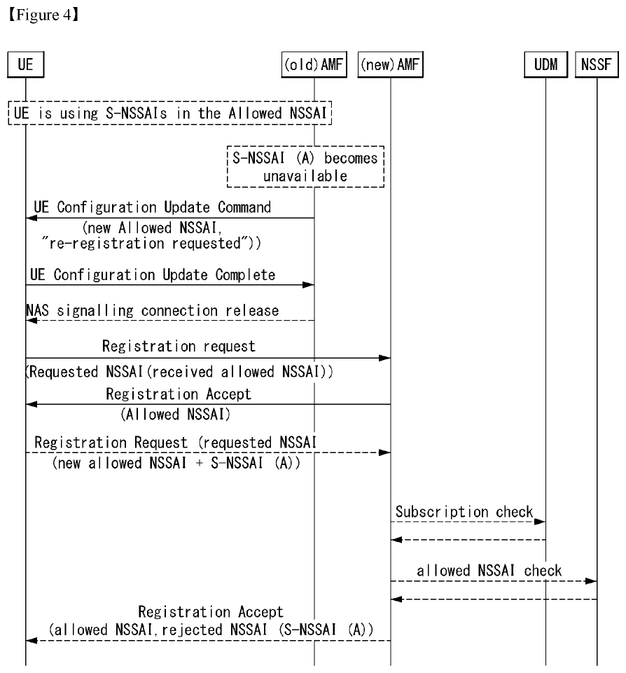

However, both the two cases may have problem illustrated in FIGS. 3 and 4:

FIG. 3 is a flowchart illustrating a problem that may occur when only allowed NSSAI is included in an UCU COMMAND message.

The network may need to allow the UE to no longer use specific S-NSSAI that the UE is using. For example, the corresponding S-NSSAI may be no longer allowed to the UE, the corresponding S-NSSAI may be no longer supported in the network, or the corresponding S-NSSAI may be temporarily unusable. In this instance, when new allowed NSSAI is included in an UCU command, the network may transmit it to the UE except unusable specific S-NSSAI. In this case, the UE may store new allowed NSSAI received except the unusable specific S-NSSAI. However, if the UE continues to use service connected to the excluded S-NSSAI, the UE may perform again a new registration procedure for the use of the corresponding S-NSSAI. However, this operation may be possible when the corresponding S-NSSAI is included in configured NSSAI of the UE, or the UE stores allowed NSSAI that the UE has previously received. The network may reject again the corresponding S-NSSAI together with a proper (rejection) cause value for the corresponding S-NSSAI. That is, the UE performs an unnecessary registration procedure for requesting the specific S-NSSAI that is already unusable. Such an unnecessary operation may include an UDM query operation for checking subscription information of the UE, and a NSSF query operation for checking whether to allow for NSSAI additionally requested by the UE, in addition to NAS signalling between the UE and the AMF.

FIG. 4 is a flow chart illustrating a problem that may occur when allowed NSSAI and (re-)registration requested information/indication are included in an UCU COMMAND message.

If the network triggers a new registration procedure using an UCU procedure, the network may transmit, to the UE, allowed NSSAI except S-NSSAI that is determined to be unusable by the network, in the same manner as FIG. 3. After the UE transitions to the CM-IDLE state, the UE may include the allowed NSSAI received from the network in requested NSSAI to perform a new registration procedure. Even in this case, the UE may still request again S-NSSAI excluded by the network, and the network may reject the corresponding S-NSSAI. That is, even in this case, unnecessary signalling may be exchanged between the UE and the network in the same manner as FIG. 3, causing signalling of the control plane and waste of radio resources.

To summarize the problems pointed out in FIGS. 3 and 4, as the allowed NSSAI is updated to the UE, even if there is S-NSSAI that is no longer allowed for the corresponding UE, information for the corresponding S-NSSAI is not transmitted to the UE in the UCU procedure. As a result, the UE may perform the unnecessary registration procedure for requesting again non-allowed S-NSSAI. This leads to unnecessary waste of signalling/resources.

Hereinafter, a solution is proposed to solve the problems illustrated in FIGS. 3 and 4.

Invention Proposal 1. Providing Rejected NSSAI Information During UCU Procedure

If the network decides that it is necessary to update allowed NSSAI that has been previously transmitted to the UE, the network may update the allowed NSSAI via a (UE) configuration update command message. In this instance, the AMF may include ‘rejected (S-)NSSAI’ as well as new allowed (S-)NSSAI in the (UE) configuration update command message.

The AMF may decide/determine/select S-NSSAI(s) that shall be temporarily or permanently removed/rejected among allowed NSSAI given to the current UE. The removed/rejected cause may include a capability problem of the network, a subscription information problem of the UE, a temporary problem, or a cause that is not currently described, etc., and the network may select that it corresponds to which rejection cause, and may indicate it to the UE. This rejection cause may be configured/determined per PLMN or per registration area. If the rejection cause corresponds to a temporary rejection cause (e.g., if a corresponding service shall stop for a specific time), the network may transmit, to the UE, a backoff timer value for a stop time together with the rejected (S-)NSSAI and/or the rejection cause.

If the UE is using a PDU session connected to S-NSSAI rejected by the network, the AMF may perform an additional operation for releasing the PDU session. The AMF may update a PDU session status for managing whether to generate the stored PDU session (delete the PDU session that has been previously present), and may deliver this state to the UE. This is included in a newly defined PDU session status IE in a UE configuration update command message and may be transmitted to the UE. In this instance, the AMF may locally perform the release for the corresponding PDU session within a core network.

The AMF includes rejected NSSAI and a (reject) cause value as well as new allowed NSSAI in a UE configuration update command. If the rejected NSSAI is included in the received UE configuration update command, the UE may store it in a rejected NSSAI list within the UE. In this instance, which list stores the rejected (S-)NSSAI may be determined depending on the received (reject) cause value. For example, the rejected (S-)NSSAI may be stored in a non-volatile memory of the UE or a SIM card of the UE. Further, the UE recognizes the received allowed NSSAI as new/valid allowed NSSAI and stores it.

If there was a PDU session connected to S-NSSSAI received via newly rejected NSSAI, the UE may perform a procedure for releasing it. This may be carried out through an explicit NAS SM PDU session release procedure. In this instance, a release cause of the corresponding PDU session may select one of existing defined causes/values such as “normal release”, or select a newly defined cause/value (e.g., “#xx Associated S-NSSAI no longer available”) for this embodiment.

If the AMF sent the UE configuration update command including a PDU session status IE, a PDU session for the rejected S-NSSAI may be released through the local release of the UE. In this case, the UE may locally release a context for the corresponding PDU session and then update a PDU session status IE to a UE configuration update complete message to send it to the AMF.

Since specific S-NSSAI has been explicitly/newly rejected through the above-described process, the UE may no longer send additional signalling for requesting service for the corresponding S-NSSAI until release conditions for the rejection are satisfied (i.e., until release conditions are again allowed).

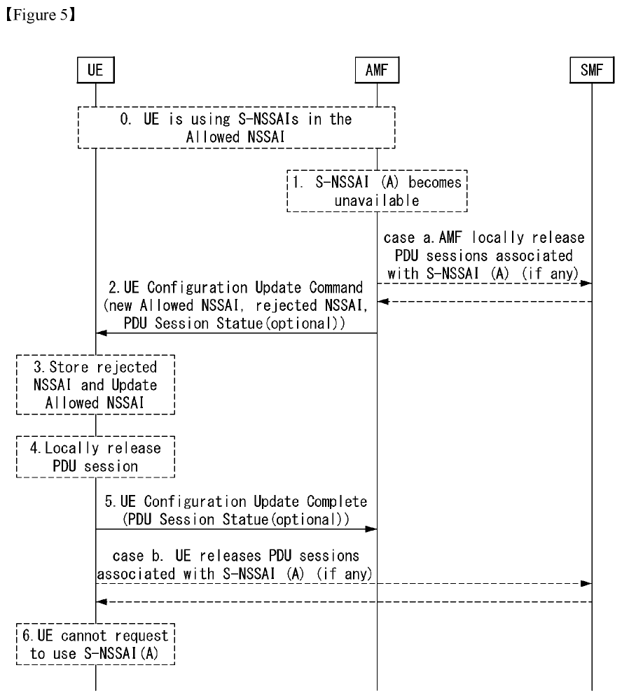

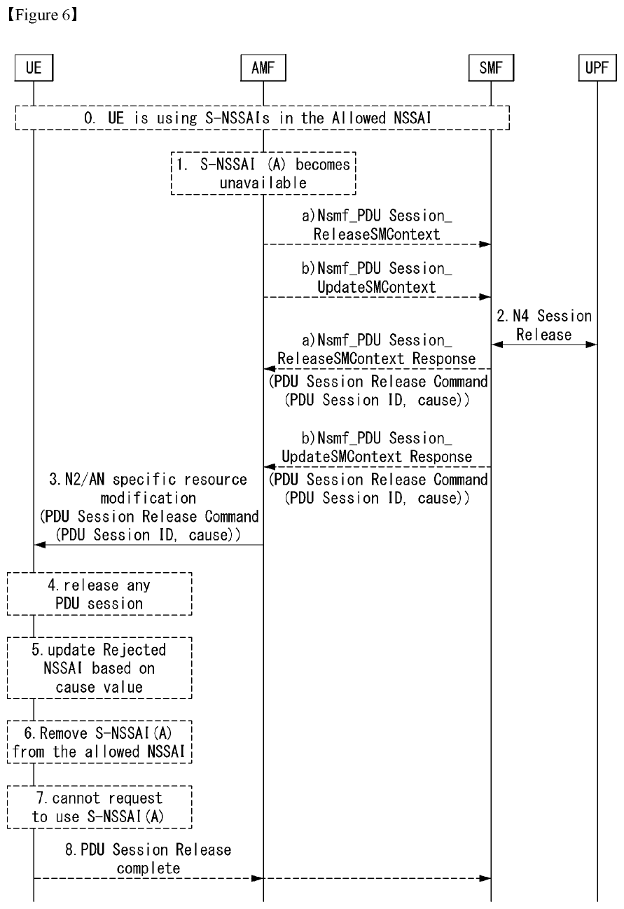

To briefly summarize a procedure of the invention proposal 1 described above, it may be the same as a flow chart of FIG. 5.

FIG. 5 illustrates an UCU procedure according to the invention proposal 1.

In this flow chart, Case a and Case b are mutually independent/parallel embodiments, and one of the two cases may be optionally applied to this flow chart. Further, at least one step in this flow chart may be deleted or newly added according to an embodiment.

0. The UE may use at least one S-NSSAI of S-NSSAIs included in allowed NSSAI.

1. In this instance, at least one S-NSSAI (e.g., A NSSAI) of the S-NSSAIs included in the allowed NSSAI may be no longer available for the UE for a specific cause.

2. The AMF may send, to the UE, a UE configuration update command including new allowed NSSAI, rejected NSSAI (e.g., A NSSAI), a rejection cause and/or a PDU session status (optional), in order to update the allowed NSSAI of the UE.

3. The UE may store the rejected NSSAI (e.g., A NSSAI) and the updated allowed NSSAI.

4. The UE may locally release a PDU session for the rejected NSSAI (e.g., A NSSAI).

5. The UE may send a UE configuration update complete message including the PDU session status (which is optional) to the AMF.

6. The UE may not request the use of the rejected S-NSSAI (e.g., A NSSAI).

The operations after the AMF sends the UE configuration update command may be performed simultaneously or sequentially, and the order of operations may change.

The Case a and the Case b correspond to parallel/independent/optional embodiments releasing the PDU session for the rejected NSSAI. In the Case a, the AMF may locally release a PDU session (if any) associated with the rejected NSSAI (e.g., A NSSAI). However, if the AMF transmits including, in the UCU command, a PDU session status for the local release of the corresponding PDU session (i.e., case a), the UE first locally releases the corresponding PDU session and then shall transmit including the PDU session status in the UCU complete. In the Case b, the UE may locally release a PDU session (if any) associated with the rejected NSSAI (e.g., A NSSAI).

Invention Proposal 2. Notifying Rejected S-NSSAI Via SM Procedure

The AMF may decide that it is necessary to update allowed NSSAI that has been previously given to the UE. In particular, if the AMF decides that S-NSSAI that the UE is using is no longer available, the AMF may operate as follows.

The AMF may decide that specific S-NSSAI of the allowed NSSAI transmitted to the UE is no longer available as described in the invention proposal 1. In this case, the AMF may first update allowed NSSAI of a UE context being stored. In order to release a PDU session associated with unavailable S-NSSAI, the AMF may send a service request to a SMF related/associated to the corresponding PDU session to release the corresponding PDU session. The service request may be, for example, Nsmf_PDUSession_ReleaseSMContext or Nsmf_PDUSession_UpdateSMContext. In this instance, the AMF includes a release request of the corresponding PDU session and a release cause in the corresponding service request. The release cause may be a cause (e.g., rejection per PLMN, rejection per registration area, temporary rejection, etc.) corresponding/equal to a currently defined S-NSSAI rejection cause, or may be a newly defined additional cause.

The SMF may generate an SM PDU session release command message for the requested PDU session. In this instance, the following value as the release cause may be newly defined and included in the SM PDU session release command message.

### Example 1

#xx. Associated S-NSSAI no longer available for PLMN;

#yy. Associated S-NSSAI no longer available for registration area;

Alternatively, not one of the above two but only one cause value as below may be defined and sent.

### Example 2

#zz. Associated S-NSSAI no longer available;

In order to send a PDU session release command including this SM cause value to the UE, the SMF first delivers it to the AMF. The AMF includes it in a DL NAS Transport message and may send it to the UE. If the SMF has not separately divide causes for several rejection scenarios, the AMF may include associated S-NSSAI and additional information (e.g., rejected/unavailable S-NSSAI, PDU session ID and/or rejection/release cause associated with rejected/unavailable S-NSSAI) in a field of the DL NAS Transport message.

If a MM layer of the UE receives the DL NAS Transport message, the MM layer may forward a SM message to a SM layer. If the additional information is included in the DL NAS Transport message, the UE may update allowed NSSAI and/or rejected NSSAI with reference to this. For example, if rejected/unavailable S-NSSAI is included as the additional information, the UE may add it to the rejected NSSAI, and/or delete it from the allowed NSSAI.

The SM layer of the UE may parse and process a PDU session release command message. In this instance, the SM layer may need to transmit the additional information to the MM layer depending on a SM cause value. If the SMF performs division for each rejection cause and commands a release, the SM layer may inform the MM layer of rejected/unavailable S-NSSAI and its rejection cause (e.g., rejection per PLMN, rejection per registration area, temporary rejection, etc.). This may be forwarded to the MM layer together when the SM layer sends the PDU session release complete message.

If the MM layer has received the additional information from the SM layer, the MM layer may properly update a rejected NSSAI list and an allowed NSSAI list depending on the rejected/unavailable S-NSSAI and the rejection cause. Afterward, the UE cannot request again the corresponding S-NSSAI until conditions for excluding specific S-NSSAI from the updated rejected NSSAI list are satisfied.

If several PDU sessions are generated via one S-NSSAI and are being served to the UE, the AMF may perform in parallel/independently the above operation for each PDU session. In this case, the UE may perform the update for the rejected NSSAI and the allowed NSSAI when processing an operation for the first received PDU session release command, and the above update operation may be skipped for a subsequently received SM procedure.

The AMF or the SMF may send only an explicit release command for a first PDU session to the UE and may process for a remaining PDU session in the form of a local release. In this case, the AMF may additionally include information such as PDU session status in the DL NAS Transport message.

To briefly summarize a procedure of the invention proposal 2 described above, it may be the same as a flow chart of FIG. 6.

FIG. 6 illustrates an UCU procedure according to the invention proposal 2.

In this flow chart, Case a and Case b are mutually independent/parallel embodiments, and one of the two cases may be optionally applied to this flow chart. Further, at least one step in this flow chart may be deleted or newly added according to an embodiment.

0. The UE may use at least one S-NSSAI of S-NSSAIs included in allowed NSSAI.

1. In this instance, at least one S-NSSAI (e.g., A NSSAI) of the S-NSSAIs included in the allowed NSSAI may be no longer available for the UE for a specific cause.

In this case, the AMF may transmit Nsmf_PDUSession_ReleaseSMContext (Case a) or Nsmf_PDUSession_UpdateSMContext (Case b) to the SMF so as to release a PDU session corresponding/associated to the corresponding S-NSSAI (e.g., A NSSAI).

2. Next, the corresponding PDU session release (i.e., N4 session release procedure) may be performed.

In this case, the SMF may transmit, to the AMF, Nsmf_PDUSession_ReleaseSMContext_Response including a PDU session release command as a response to Nsmf_PDUSession_ReleaseSMContext (Case a). In this instance, the PDU session release command may include a PDU session ID to be released and/or a release cause. Alternatively, the SMF may transmit, to the AMF, Nsmf_PDUSession_UpdateSMContext_Response including the PDU session release command as a response to Nsmf_PDUSession_UpdateSMContext (Case b). In this instance, the PDU session release command may include a PDU session ID to be released and/or a release cause.

3. The AMF may send a N2/AN specific resource modification message including the PDU session release command to the UE.

4. The UE may release a PDU session indicated via the PDU session release command.

5. The UE may update rejected NSSAI based on the received PDU session release command (particularly, release/reject cause value).

6. The UE may delete rejected S-NSSAI (e.g., A S-NSSAI) (i.e., S-NSSAI corresponding to PDU session (ID) to be released) from the allowed NSSAI based on the received PDU session release command.

7. The UE does not request to use S-NSSAI included in the rejected NSSAI.

8. The UE may send a message informing the completion of PDU session release to the SMF.

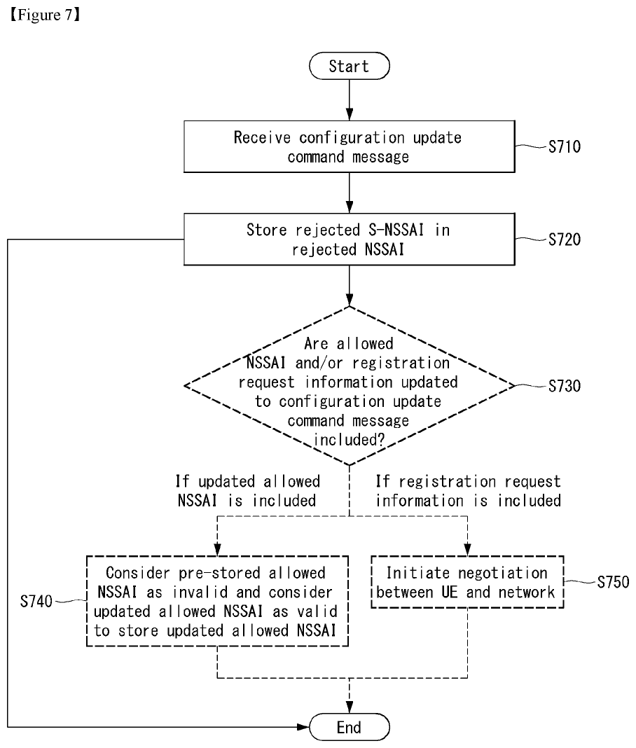

FIG. 7 is a flow chart illustrating an UCU method of a UE according to an embodiment of the present disclosure. The embodiments described above and the description can be applied equally/similarly in relation to this flowchart, and duplicate description is omitted. In addition, steps S730 to S750 in this flow chart may be omitted or optionally performed according to embodiments. The order of at least some steps in this flowchart may be changed, or anew step may be added.

First, a UE may receive a configuration update command message for updating a configuration of the UE from an AMF in S710. The configuration update command message may include at least one rejected S-NSSAI for the UE and a rejection cause.

Next, the UE may store rejected S-NSSAI in rejected NSSAI based on the received rejection cause in S720. More specifically, the UE may divide the rejected S-NSSAI per each rejection cause and add/store it to the rejected NSSAI (i.e., update the rejected NSSAI). For example, the rejection cause may be configured to indicate that the rejected S-NSSAI is not available in a current PLMN of the UE, and/or the rejected S-NSSAI is not available in a current registration area of the UE.

The configuration update command message may further include allowed NSSAI updated for the UE. If the configuration update command message includes the updated allowed NSSAI in S730 and S740, the UE may (consider pre-stored allowed NSSAI as invalid, and) consider the updated allowed NSSAI as valid to store the updated allowed NSSAI. If the configuration update command message includes registration request information requesting the UE's registration, negotiation between the UE and the network may be initiated in S730 and S750.

Although not shown in this flow chart, if S-NSSAI associated with a currently active PDU session for the corresponding UE is not included in the updated allowed NSSAI, and/or is included in the rejected NSSAI, the AMF sending the configuration update command message may inform/request/indicate the release of the PDU session to a SMF associated with the PDU session.

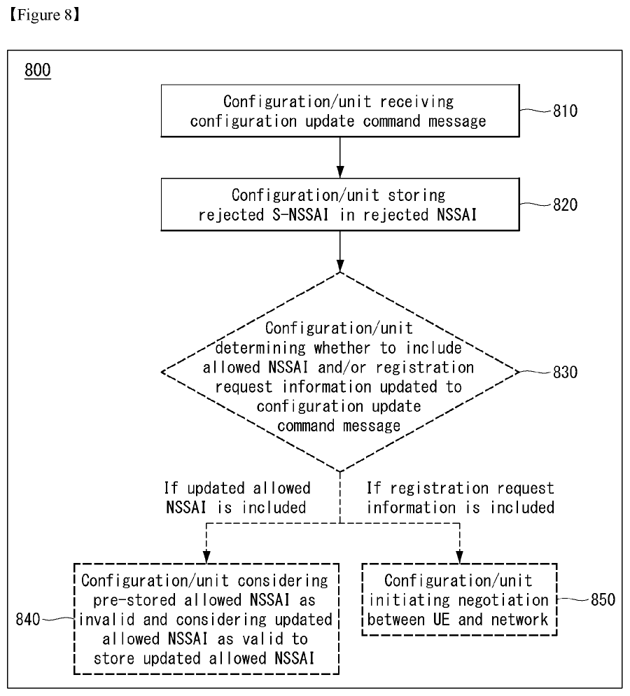

FIG. 8 is a block diagram of a UE performing an UCU method according to an embodiment of the present disclosure. The description of FIG. 7 can be applied equally/similarly to FIG. 8, and duplicate description is omitted.

A UE 800 may basically include a configuration/unit 810 receiving a configuration update command message and a configuration/unit 820 storing rejected S-NSSAI in rejected NSSAI. In addition, the UE 800 may include a configuration/unit 830 determining whether to include allowed NSSAI and/or registration request information updated to the configuration update command message according to embodiments, a configuration/unit 840 storing updated allowed NSSAI, and/or a configuration/unit 850 initiating negotiation between a UE and a network.

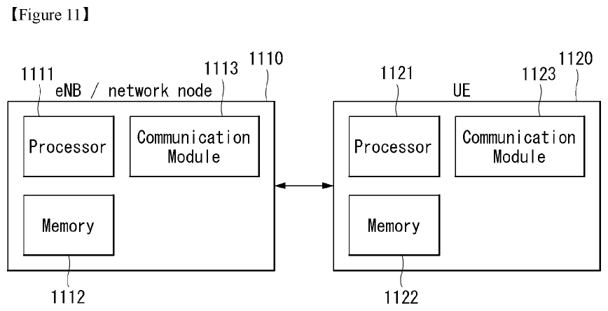

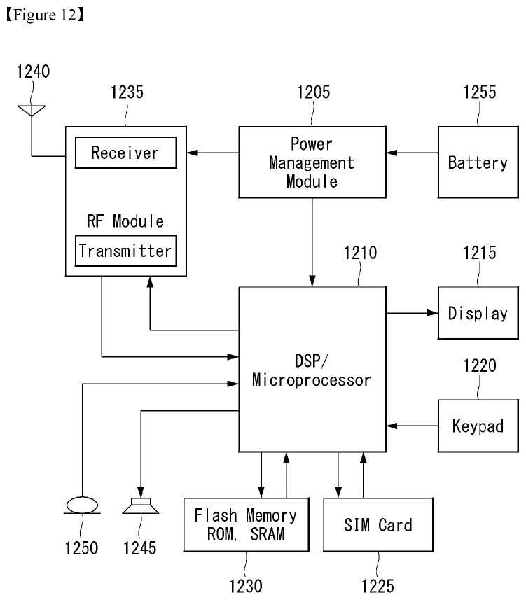

The configurations/units 810 to 850 of the UE 800 may be configurations/units configured to respectively perform the steps S710 to S750 in the flow chart of FIG. 7. Each configuration/unit may be comprised of hardware components/parts, and may correspond to a processor, a memory and/or a communication module, or a combination thereof described below with reference to FIGS. 11 and 12.

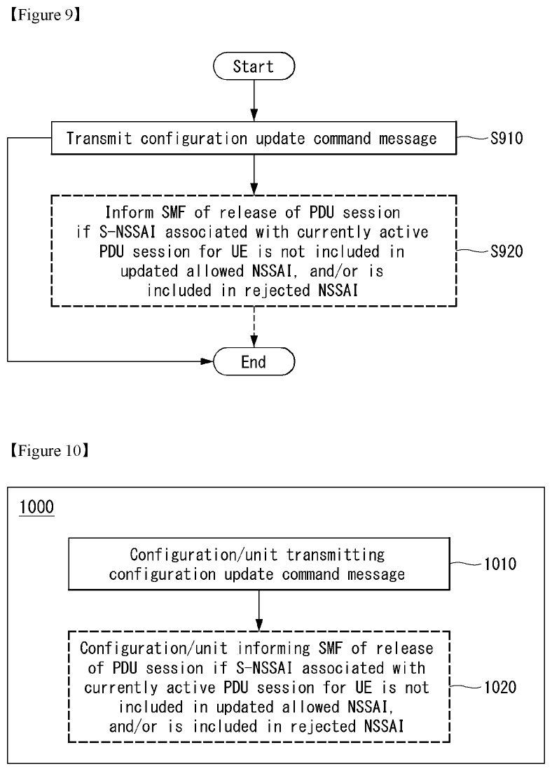

FIG. 9 is a flow chart illustrating an UCU method of an AMF according to an embodiment of the present disclosure. The embodiments described above and the description can be applied equally/similarly in relation to this flow chart, and duplicate description is omitted. In addition, step S920 in this flow chart may be omitted or optionally performed according to embodiments. The order of at least some steps in this flowchart may be changed, or anew step may be added.

First, an AMF may send a configuration update command message for updating a configuration of the UE to a UE in S910. The configuration update command message may include rejected S-NSSAI for the UE and a rejection cause.

Next, if S-NSSAI associated with a currently active PDU session for the UE is not included in the updated allowed NSSAI, and/or is included in the rejected NSSAI, the AMF may inform/request/indicate the release of the PDU session to a SMF associated with the PDU session.

FIG. 10 is a block diagram of an AMF performing an UCU method according to an embodiment of the present disclosure. The description of FIG. 9 can be applied equally/similarly to FIG. 10, and duplicate description is omitted.

An AMF 1000 may basically include a configuration/unit 1010 sending a configuration update command message. In addition, the AMF 1000 may include a configuration/unit 1020 informing a SMF of a release of a PDU session if S-NSSAI associated with a currently active PDU session for the UE is not included in the updated allowed NSSAI, and/or is included in the rejected NSSAI according to embodiments.

The configurations/units 1010 and 1020 of the AMF 1000 may be configurations/units configured to respectively perform the steps S910 and S920 in the flow chart of FIG. 9. Each configuration/unit may be comprised of hardware components/parts, and may correspond to a processor, a memory and/or a communication module, or a combination thereof described below with reference to FIGS. 11 and 12.

Overview of Device to which the Present Disclosure is Applicable

FIG. 11 illustrates a block diagram of a communication apparatus according to an embodiment of the present disclosure.

Referring to FIG. 11, a wireless communication system includes a network node 1110 and a plurality of UEs (UE) 1120.

The network node 1110 includes a processor 1111, a memory 1112, and a communication module 1113. The processor 1111 implements the previously proposed functions, processes and/or methods. The layers of the wired/wireless interface protocol may be implemented by the processor 1111. The memory 1112 is connected to the processor 1111 and stores various information for driving the processor 1111. The communication module 1113 is connected to the processor 1111 to transmit and/or receive a wired/wireless signal. Some examples of the network node 1110 may include a base station, an MME, an HSS, an SGW, a PGW, and an application server. In particular, when the network node 1110 is a base station, the communication module 1113 may include a radio frequency unit for transmitting/receiving a radio signal.

The UE 1120 includes a processor 1121, a memory 1114 and a communication module (or RF section). Processor 1121 implements the previously proposed functions, processes and/or methods. The layers of the wireless interface protocol may be implemented by the processor 1121. The memory 1114 is connected to the processor 1121 and stores various information for driving the processor 1121. The communication module 1123 is coupled to processor 1121 to transmit and/or receive wireless signals.

The memories 1112 and 1114 may be located inside or outside the processors 1111 and 1121 and may be coupled to the processors 1111 and 1121 by various well known means. Also, the network node 1110 (in the case of a base station) and/or the UE 1120 may have a single antenna or multiple antennas.

FIG. 12 shows a block diagram of a communication apparatus according to an embodiment of the present disclosure.

Specifically, FIG. 12 is a more detailed diagram of the UE of FIG. 11.

Referring to FIG. 12, the UE may include a processor (or digital signal processor (DSP)) 1210, an RF module (or RF unit) 1235, a power management module 1205, an antenna 1240, a battery 1255, a display 1215, a keypad 1220, memory 1230, a subscriber identification module (SIM) card 1225 (this element is optional), a speaker 1245 and a microphone 1250. The UE may also include a single antenna or multiple antennas.

The processor 1210 implements the functions, processes and/or methods proposed above. The layers of a radio interface protocol may be implemented by the processor 1210.

The memory 1230 is connected to the processor 1210 and stores information related to the operation of the processor 1210. The memory 1230 may be located inside or outside the processor 1210 and may be connected to the processor 1210 by well-known various means.

A user inputs command information, such as a telephone number, by pressing (or touching) a button of the keypad 1220 or by voice activation using the microphone 1250, for example. The processor 1210 processes a proper function, such as receiving such command information or making a call to a telephone number, so that the function is performed. Operational data may be extracted from the SIM card 1225 or the memory 1230. Furthermore, the processor 1210 may display command information or driving information on the display 2135 so that a user can recognize the information or for convenience.

The RF module 1235 is connected to the processor 1210 and transmits and/or receives RF signals. The processor 1210 transfers command information to the RF module 1235 so that a radio signal forming voice communication data, for example, is transmitted in order to initiate communication. The RF module 1235 includes a receiver and a transmitter in order to transmit and receive radio signals. The antenna 1240 functions to transmit and receive radio signals. When the RF module 1235 receives a radio signal, it transfers the signal for the processing of the processor 1210 and may convert the signal into a baseband. The processed signal may be converted into audible or readable information through the speaker 1245.

In the aforementioned embodiments, the elements and characteristics of the present disclosure have been combined in specific forms. Each of the elements or characteristics may be considered to be optional unless otherwise described explicitly. Each of the elements or characteristics may be implemented in a form to be not combined with other elements or characteristics. Furthermore, some of the elements and/or the characteristics may be combined to form an embodiment of the present disclosure. Order of the operations described in the embodiments of the present disclosure may be changed. Some of the elements or characteristics of an embodiment may be included in another embodiment or may be replaced with corresponding elements or characteristics of another embodiment. It is evident that an embodiment may be constructed by combining claims not having an explicit citation relation in the claims or may be included as a new claim by amendments after filing an application.

The embodiment according to the present disclosure may be implemented by various means, for example, hardware, firmware, software or a combination of them. In the case of an implementation by hardware, the embodiment of the present disclosure may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In the case of an implementation by firmware or software, the embodiment of the present disclosure may be implemented in the form of a module, procedure or function for performing the aforementioned functions or operations. Software code may be stored in the memory and driven by the processor. The memory may be located inside or outside the processor and may exchange data with the processor through a variety of known means.

In the present disclosure, ‘A and/or B’ can be interpreted to mean ‘at least one of A and(or) B’.

It is evident to those skilled in the art that the present disclosure may be materialized in other specific forms without departing from the essential characteristics of the present disclosure. Accordingly, the detailed description should not be construed as being limitative from all aspects, but should be construed as being illustrative. The scope of the present disclosure should be determined by reasonable analysis of the attached claims, and all changes within the equivalent range of the present disclosure are included in the scope of the present disclosure.

### INDUSTRIAL APPLICABILITY

Although the present disclosure has been described focusing on examples applying to the 3GPP LTE/LTE-A/NR (5G) system, the present disclosure can be applied to various wireless communication systems other than the 3GPP LTE/LTE-A/NR (5G) system.

1. A user equipment configuration update (UCU) method of a user equipment (UE) in a wireless communication system, the UCU method comprising:
receiving a configuration update command message for updating a configuration of the UE from an access and mobility management function (AMF), the configuration update command message including rejected network slice selection assistance information (NSSAI), the rejected NSSAI including at least one rejected single-network slice selection assistance information (S-NSSAI) to be added rejected NSSAI in the UE with a rejection cause, based on the rejection cause.

2. The UCU method of claim 1, wherein the rejected S-NSSAI is comprised of a slice/service type (SST) and a slice differentiator (SD).

3. The UCU method of claim 2, wherein the SST refers to an expected network slice behavior in terms of features and services,
wherein the SD refers to optional information that complements the SST to differentiate among multiple network slices of the same slice/service type.

4. The UCU method of claim 3, wherein the configuration update command message further includes allowed NSSAI updated for the UE.

5. The UCU method of claim 4, further comprising, based on the configuration update command message including the updated allowed NSSAI, storing the updated allowed NSSAI based on considering the updated allowed NSSAI as valid.

6. The UCU method of claim 4, wherein based on the configuration update command message including registration requested requesting a registration of the UE, a negotiation between the UE and a network is initiated.

7. The UCU method of claim 4, wherein the rejection cause indicates that the rejected S-NSSAI is not available in a current public land mobile network (PLMN) of the UE, and/or the rejected S-NSSAI is not available in a current registration area of the UE.

8. The UCU method of claim 7, wherein the rejected S-NSSAI is added the rejected NSSAI in the UE, based on dividing the rejected S-NSSAI per the rejection cause.

9. The UCU method of claim 8, wherein based on S-NSSAI associated with a currently active protocol data unit (PDU) session being not included in the updated allowed NSSAI, and/or being included in the rejected NSSAI in the UE, the AMF is a network node informing a release of the PDU session to a SMF associated with the PDU session.

10. A user equipment (UE) performing a user equipment configuration update (UCU) method in a wireless communication system, the UE comprising:
a communication module configured to transmit and receive a signal;
a memory configured to store data; and
a processor configured to control the communication module and the memory,
wherein the processor is configured to:
receive a configuration update command message for updating a configuration of the UE from an access and mobility management function (AMF), the configuration update command message including rejected network slice selection assistance information (NSSAI), the rejected NSSAI including at least one rejected single-network slice selection assistance information (S-NSSAI) to be added rejected NSSAI in the UE with a rejection cause, based on the rejection cause.

11. The UE of claim 10, wherein the configuration update command message further includes allowed NSSAI updated for the UE.

12. The UE of claim 11, wherein based on the configuration update command message including the updated allowed NSSAI, the processor is configured to store the updated allowed NSSAI based on considering the updated allowed NSSAI as valid.

13. The UE of claim 11, wherein based on the configuration update command message including registration request information, a negotiation between the UE and a network is initiated.

14. The UE of claim 11, wherein the rejection cause indicates that the rejected S-NSSAI is not available in a current public land mobile network (PLMN) of the UE, and/or the rejected S-NSSAI is not available in a current registration area of the UE.

15. The UE of claim 14, wherein based on the rejected S-NSSAI being stored in the rejected NSSAI based on the rejection cause, the processor is configured to store the rejected S-NSSAI in the rejected NSSAI based on dividing the rejected S-NSSAI per the rejection cause.

16. The UE of claim 15, wherein based on S-NSSAI associated with a currently active protocol data unit (PDU) session being not included in the updated allowed NSSAI, and/or being included in the rejected NSSAI, the AMF is a network node informing a release of the PDU session to a SW associated with the PDU session.

17. An access and mobility management function (AMF) performing a user equipment configuration update (UCU) method in a wireless communication system, the AMF comprising:
a communication module configured to transmit and receive a signal;
a memory configured to store data; and
a processor configured to control the communication module and the memory,
wherein the processor is configured to:
send a configuration update command message for updating a configuration of a user equipment (UE) to the UE,
wherein the configuration update command message includes rejected network slice selection assistance information (NSSAI), and
wherein the rejected NSSAI includes at least one rejected single-network slice selection assistance information (S-NSSAI) to be added rejected NSSAI in the UE with a rejection cause, based on the rejection cause.

18. The UCU method of claim 1, wherein the rejected NSSAI including 1) multiple S-NSSAIs to be added rejected NSSAI in the UE and 2) multiple rejection causes related with the S-NSSAI.

19. The UCU method of claim 1, further comprising, storing the rejected S-NSSAI in rejected NSSAI based on the rejection cause.
